(19) United States
(12) Patent Application Publication
(10) Pub. No.: US 2010/0027387 A1
(43) Pub. Date: Feb. 4, 2010

(54) INFORMATION RECORDING APPARATUS, MEDIUM, AND PROGRAM

(75) Inventors: Akira Shirota, Saitama-shi (JP); Atsushi Yamaguchi, Tokorozawa-shi (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 12/521,200

(22) PCT Filed: Dec. 27, 2006
(86) PCT No.: PCT/JP2006/326029

§ 371 Date: Jun. 25, 2009

(51) Int. Cl. G11B 20/10

(52) U.S. Cl. 369/47.5; G9B/20.009

(57) ABSTRACT

An information recording apparatus changes a write strategy to reduce a pulse width of a write pulse to write a minimum mark, and records data based on the changed write strategy.

### TECHNICAL FIELD OF THE INVENTION

The present invention relates to techniques for recording information on an information storage medium, and more particularly to techniques for controlling regeneration characteristics.

### BACKGROUND ART

Recordable DVDs, such as Write-Once DVD-R disks or Rewritable DVD-RW disks have characteristics capable of semipermanently storing therein records and of repeatedly reproducing the records.

Depending on information of contents to be recorded in an optical disc, the period allowed for reproduction of the contents and a reproducible number of the contents can be limited. As such reproduction limiting techniques, there are playback-time limited disks with reproduction characteristics that are intentionally-deteriorated to limit reproducible period (see Patent Document 1).

Patent document 1: Japanese Patent Laid-Open No. 2003-173566

### DISCLOSURE OF THE INVENTION

### Problems to be Solved by the Invention

However, in these playback-time limited disks, it may be difficult to freely set a reproducible period when data is recorded in a playback-time limited disk.

In addition, the reproduction characteristics of a playback-time limited disk may be deteriorated with the playback-time limited disk being reproduced. In other words, a playback-time limited disk cannot be applicable to needs for preventing the reproduction characteristics from being deteriorated.

The present invention has been made in order to solve the above mentioned problems, and has an object, for example, of providing information recording apparatuses, programs, and recording media, which are capable of flexibly setting a reproduction characteristic depending on the application.

### Means for Solving the Problems

In order to achieve the object provided above, an information reproduction apparatus recited in claim 1 includes recording condition determining means for determining a recording condition to recode data on an information recording medium, and reproducible period inputting means for inputting a parameter value associated with a reproducible period. The information reproduction apparatus includes recording condition changing means for changing, based on the parameter value inputted by the reproducible period inputting means, a recording condition associated with a write strategy in the recording condition determined by the recording condition determining means. The information reproduction apparatus includes information recording means for recording, on the information recording medium, data based on the recording condition changed by the recording condition changing means and associated with the write strategy. The recording condition associated with the write strategy includes a rate of a pulse width of a write signal to write a short mark to a pulse width of a write signal to write a long mark. The short mark has a length shorter than a predetermined length. The long mark has a length longer than the predetermined length. The recording condition changing means reduces the rate determined by the recording condition determining means.

An information recording apparatus recited in claim 5 includes recording condition determining means for determining a recording condition to recode data on an information recording medium, and reproducible period inputting means for inputting a parameter value associated with a reproducible period. The information reproduction apparatus includes recording condition changing means for changing, based on the parameter value inputted by the reproducible period inputting means, a recording condition associated with a write power in the recording condition determined by the recording condition determining means, and information recording means for recording, on the information recording medium, data based on the recording condition changed by the recording condition changing means and associated with the write power. The recording condition associated with the write power includes a rate of a write power level of a write signal to write a short mark to a write power level of a write signal to write a long mark. The short mark has a length shorter than a predetermined length, and the long mark has a length longer than the predetermined length. The recording condition changing means reduces the rate determined by the recording condition determining means.

An information recording apparatus recited in claim 11 includes recording condition determining means for determining a recording condition to recode data on an information recording medium, and reproducible period inputting means for inputting a parameter value associated with a reproducible period. The information recording apparatus includes recording condition changing means for changing, based on the parameter value inputted by the reproducible period inputting means, a recording condition associated with a write power in the recording condition determined by the recording condition determining means, and information recording means for recording, on the information recording medium, data based on the recording condition changed by the recording condition changing means and associated with the write power. The recording condition associated with the write power includes a write power level of each of a plurality of write signals to write a plurality of marks, respectively. Each of the plurality of marks has a length. The recording condition changing means carries out the recording such that the write power level of each of the plurality of write signals to write the plurality of marks is reduced than an optimum write power level determined by the recording condition determining means.

An information recording apparatus recited in claim 12 includes recording condition determining means for determining a recording condition to recode data on an information recording medium, and reproducible number inputting means for inputting a parameter value associated with a reproducible number. The information recording apparatus includes recording condition changing means for changing, based on the parameter value inputted by the reproducible number inputting means, a recording condition associated with a write strategy in the recording condition determined by the recording condition determining means. The information recording apparatus includes information recording means for recording, on the information recording medium, data based on the recording condition changed by the recording condition changing means and associated with the write strategy. The recording condition associated with the write strategy includes a length of a pulse width of a write signal to write a mark, and the recording condition changing means reduces the length of the pulse width of the write signal determined by the recording condition determining means.

An information recording apparatus recited in claim 17 includes means for obtaining information associated with an information recording medium, the information being stored in the information recording medium, and means for determining, based on a write strategy of the obtained information or information previously stored in the apparatus, an optimum write power level that does not deteriorate a reproducing characteristic. The information recording apparatus includes means for inputting a parameter value associated with deterioration of the reproducing characteristic, means for changing, based on the inputted parameter value, the write strategy or the determined optimum write power level after the optimum write power level has been determined, and means for recording data on the information recording medium according to the changed write strategy or the changed write power level.

An information recording medium recited in claim 18 includes data recorded therein by the information recording apparatus according to any one of claims 1 to 17.

An information recording program recited in claim 21 functions a computer as:

recording condition determining means for determining a recording condition to recode data on an information recording medium;

reproducible period inputting means for inputting a parameter value associated with a reproducible period;

recording condition changing means for changing, based on the parameter value inputted by the reproducible period inputting means, a recording condition associated with a write strategy in the recording condition determined by the recording condition determining means; and

information recording means for recording, on the information recording medium, data based on the recording condition changed by the recording condition changing means and associated with the write strategy. The recording condition associated with the write strategy includes a rate of a pulse width of a write signal to write a short mark to a pulse width of a write signal to write a long mark. The short mark has a length shorter than a predetermined length, and the long mark has a length longer than the predetermined length. The recording condition changing means reduces the rate determined by the recording condition determining means.

An information recording program recited in claim 22 functions a computer as:

recording condition determining means for determining a recording condition to recode data on an information recording medium;

reproducible period inputting means for inputting a parameter value associated with a reproducible period;

recording condition changing means for changing, based on the parameter value inputted by the reproducible period inputting means, a recording condition associated with a write power in the recording condition determined by the recording condition determining means; and

information recording means for recording, on the information recording medium, data based on the recording condition changed by the recording condition changing means and associated with the write power. The recording condition associated with the write power includes a rate of a write power level of a write signal to write a short mark to a write power level of a write signal to write a long mark. The short mark has a length shorter than a predetermined length, and the long mark has a length longer than the predetermined length. The recording condition changing means reduces the rate determined by the recording condition determining means.

An information recording program recited in claim 23 functions a computer as:

recording condition determining means for determining a recording condition to recode data on an information recording medium;

reproducible number inputting means for inputting a parameter value associated with a reproducible number;

recording condition changing means for changing, based on the parameter value inputted by the reproducible number inputting means, a recording condition associated with a write strategy in the recording condition determined by the recording condition determining means; and

information recording means for recording, on the information recording medium, data based on the recording condition changed by the recording condition changing means and associated with the write strategy. The recording condition associated with the write strategy includes a length of a pulse width of a write signal to write a mark, and the recording condition changing means reduces the length of the pulse width of the write signal determined by the recording condition determining means.

### BRIEF DESCRIPTION OF THE DRAWINGS

FIG. 1 is a view illustrating recording characteristics of an information recording medium according to one embodiment of the present invention;

FIG. 2 is a schematic structural view of an information recording apparatus according to the one embodiment of the present invention;

FIG. 3 is an example of a change correspondence table of recording conditions in the information recording apparatus according to the one embodiment of the present invention;

FIG. 4 is a flowchart representing operations of the information recording apparatus according to the one embodiment of the present invention;

FIG. 5 is a view illustrating write strategies for write pulses according to an example 1;

FIG. 6 is a table illustrating change in jitter values over time when data is recorded using the write strategies illustrated in FIG. 5;

FIG. 7 is a table illustrating reproducing conditions according to the example 1;

FIG. 8 is a view illustrating write strategies for write pulses according to an example 2;

FIG. 9 is a table illustrating change in jitter values over time when data is recorded using the write strategies illustrated in FIG. 8;

FIG. 10 is a table illustrating reproducing conditions according to the example 2;

FIG. 11 is a view illustrating write strategies for write pulses according to a modification of the example 2;

FIG. 12 is a view illustrating write strategies for write pulses according to another modification of the example 2;

FIG. 13 is a view illustrating write power levels for write pulses according to an example 3;

FIG. 14 is a view illustrating write strategies for write pulses according to an example 4;

FIG. 15 is a view illustrating write strategies write powers for write pulses according to an example 5;

FIG. 16 is a view illustrating recording characteristics according to an example 6:

FIG. 17 is a view illustrating write strategies of write pulses according to a next embodiment;

FIG. 18 is a table illustrating change in jitter values when data is recorded using the write strategies illustrated in FIG. 17; and

FIG. 19 is a table illustrating reproducing conditions according to the next embodiment.

### DESCRIPTION OF CHARACTERS

1, 1A Optical disk

2 Irradiating unit

3 Receiving unit

4 Slider

5 Radial position detector

6 Driver

7 Measuring unit

8 Write power selector

9 Disk-information obtaining unit

10 Recording condition controller

11 Write pulse generator

100, 100A Information recording apparatus

### BEST MODES FOR CARRYING OUT THE INVENTION

Embodiments of the present invention will be described hereinafter with reference to the drawings.

Before describing an information recording apparatus 100 according to the one embodiment, recording characteristics (regeneration characteristics) of an optical disk 1 of an information recording medium to be used in the one embodiment will be described hereinafter.

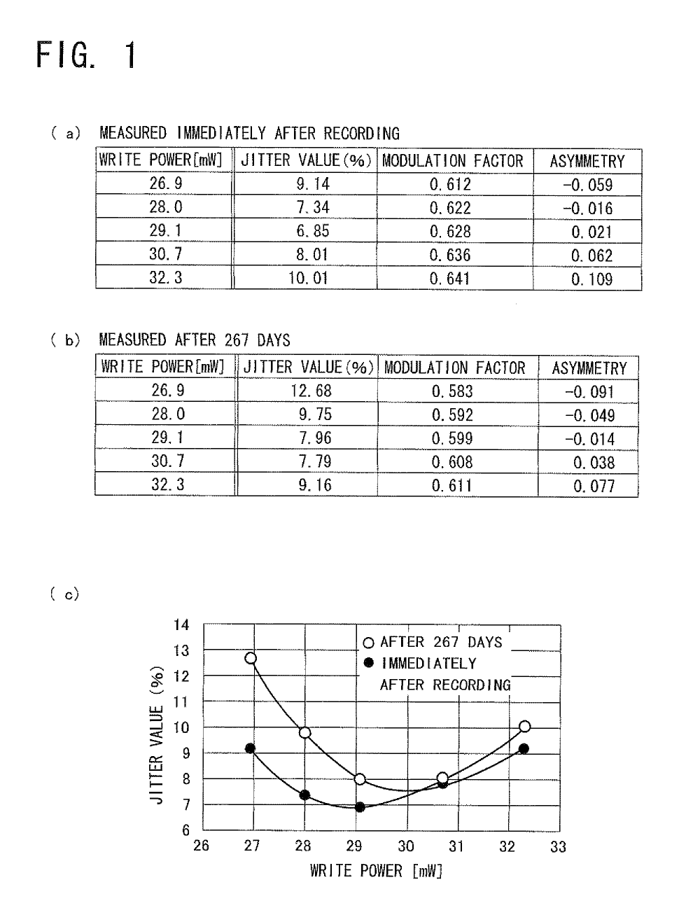

FIG. 1 illustrates measured values indicative of the recording characteristics of the optical disk 1 to be used in the one embodiment. (a) of FIG. 1 demonstrates the recording characteristics immediately after the recoding of the data, and (b) of FIG. 1 demonstrates the recording characteristics after 267 days. (c) of FIG. 1 represents the jitter characteristics illustrated in (a) and (b) of FIG. 1 as a graph with the vertical axis showing jitter values and the horizontal axis showing the recording power levels. Note that jitter value represents the quality of recording characteristic, and therefore the lower a jitter value is, the higher the quality of a recording characteristic is.

Note that, as the optical disk 1, a Write-Once DVD-R disk is used, and the recording layer of the optical disk 1 consists of a cyanine dye having a high light degradation. The cyanine dye is normally used in combination with a light resistant agent for normally reducing light deterioration, and in the one embodiment, a reduction in the amount of the light resistant agent is more effective than use of a normal amount of the light resistant agent.

In addition, the recording characteristics illustrated in FIG. 1 are measured when the data is recorded on the optical disk 1 at 8× write speed using an optimum write strategy.

As illustrated in (a) and (c) of FIG. 1, an optimum write power level immediately after the recording is 29 mW, the recording characteristic immediately after the recording at the write power of 29 mW includes the jitter value of 6.9%, the modulation factor of 63%, and the value of asymmetry of 2.1%.

In contrast, the jitter value, the modulation factor, and the value of asymmetry of the recording characteristic of the recorded portion (the recorded portion at the write power of 29 mW) 267 days are changed to the jitter value of 8.0%, the modulation factor of 60%, and the value of asymmetry of −1.4%.

From the recording characteristic change, the following phenomena can occur in the optical disk 1.

First, the reduction in the modulation factor from 63% to 60% can reduce the lengths of recorded marks with time. Next, the reduction in the value of asymmetry from 2.1% to −1.4% can reduce the lengths of short recorded marks relative to those of long recorded marks. The optical disk 1 according to the one embodiment has a tendency to break the balance between the long recorded marks, referred to simply as “long marks”, and the short recorded marks, referred to as “short marks”. This may cause the jitter values to deteriorate.

It follows from what has been described that setting either the following first recording condition (1) or second recording condition (2) allows the recording characteristics to be intentionally deteriorated over time:

(1) the rate of the width of a write signal to write a short mark to the width of a write signal to record a long mark is more reduced than that during optimum recording

(2) the rate of the power of a write signal to write a short mark to the power of a write signal to record a long mark is more reduced than that during optimum recording

Specifically, setting either the first recording condition (1) or the second recording condition (2) permits the recording characteristics to be intentionally deteriorated, thus limiting the time allowed for reproduction. Note that a write signal to write a short mark will be referred to as “a write pulse for a short mark”, and a write signal to write a long mark will be referred to as “a write pulse for a long mark”.

For example, a reduction in the width of a write pulse for a minimum mark (3 T) or an increase in the width of a write pulse for a preset long mark meets the first recording condition (1). This therefore intentionally deteriorates the recording characteristics to thereby limit a reproducible period. Moreover, a reduction in the power of a write pulse for a minimum mark or an increase in the power of a write pulse for a preset long mark meets the second recording condition (2). This therefore intentionally deteriorates the recording characteristics to thereby limit a reproducible period.

Note that short marks according to the one embodiment are marks each with a length shorter than the diameter of a laser beam spot focused on the optical disk 1 for data recording or data playback. Similarly, note that long marks according to the one embodiment are marks each with a length longer than the diameter of a laser beam spot focused on the optical disk 1 for data recording or data playback

For example, for DVD-R disks, the short marks include a mark based on the write pulse width of 3 T, a mark based on the write pulse width of 4 T, and a mark based on the write pulse width of 5 T. For DVD-R disks, the long marks include a mark based on the write pulse width of 6 T, a mark based on the write pulse width of 7 T, a mark based on the write pulse width of 8 T, a mark based on the write pulse width of 9 T, a mark based on the write pulse width of 10 T, a mark based on the write pulse width of 11 T, and a mark based on the write pulse width of 14 T.

The information recording apparatus 100 according to the one embodiment for controlling the write strategy and the write power based on the deterioration characteristics of the optical disk 1 over time will be described hereinafter. Note that control of the write strategy according to the one embodiment means control of the width of a write pulse except for control of the power of a write pulse.

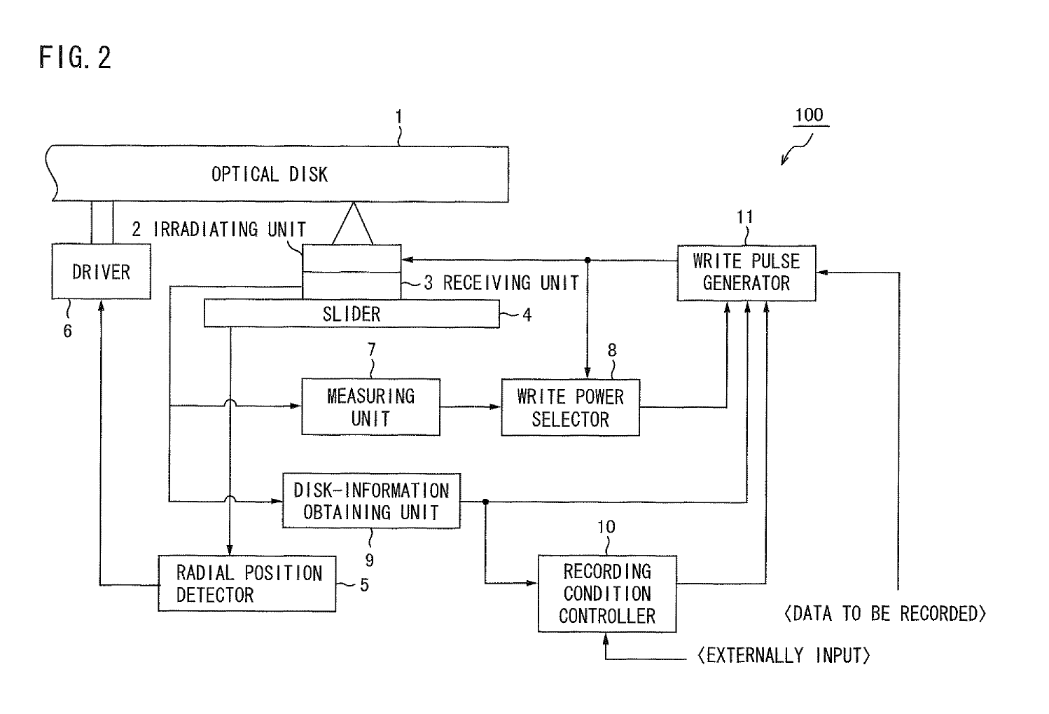

FIG. 2 is a schematic structural view of the information recording apparatus 100 according to the one embodiment of the present invention. The information recording apparatus 100 can be designed as a computer equipped with a DVD (Digital Versatile Disk) recorder or a DVD drive. The information recording apparatus 100 records information on the optical disk 1.

An irradiating unit 2 consists mainly of a laser diode (LD), and is adapted to irradiate a laser beam to the optical disk 1 to thereby carry out recording and playback of information on the optical disk 1.

A receiving unit 3 consists mainly of a photo diode (PD), and is configured to receive light reflected from the optical disk 1 based on the irradiated laser beam.

A slider 4 is adapted to move, in the radial direction of the optical disk 1, a pickup head unit (PUH) consisting mainly of the irradiating unit 2 and the receiving unit 3.

A radial position detector 5 is adapted to detect a radial position of the PUH, and to send, to a driver 6, information indicative of the radial position of the PUH.

The driver 6 is operative to control the rotation of the optical disk 1 based on the radial-position information sent from the radial position detector 5.

A reproducing characteristic measuring unit 7 is adapted to measure reproducing characteristics of a portion recorded at OPC (Optimum Power Control), and send, to a write power selector 8, a result of the measurement.

The write power selector 8 is configured to select a write power level based on a write power level for the OPC and the reproducing characteristics sent from the reproducing characteristic measuring unit 7. The selected write power level allows the reproducing characteristics to be most improved. The write power level for the OPC is changed stepwisely in order to determine an optimum write power level.

The write power selector 8 is also configured to send, to a write pulse generator 11, information associated with the optimum write power level.

A disk information obtaining unit 9 is adapted to obtain disk information previously stored in the optical disk 1; this disk information of the optical disk 1 includes its manufacture, its model number, its write strategy, and the like.

A recording condition controller 10 is configured to change the recording conditions based on the disk information obtained by the disk information obtaining unit 9 and externally input information; these recording conditions include the write strategy (the widths of write pulses), the write power, and the like. The externally input information includes information for limiting the reproducing characteristics including a reproducible period.

The recording condition controller 10 is also configured to send, to the write pulse generator 11, information associated with the changed recording conditions.

Specifically, the recording condition controller 10 is adapted to change the recording conditions including the first recording condition (1) and the second recording condition (2).

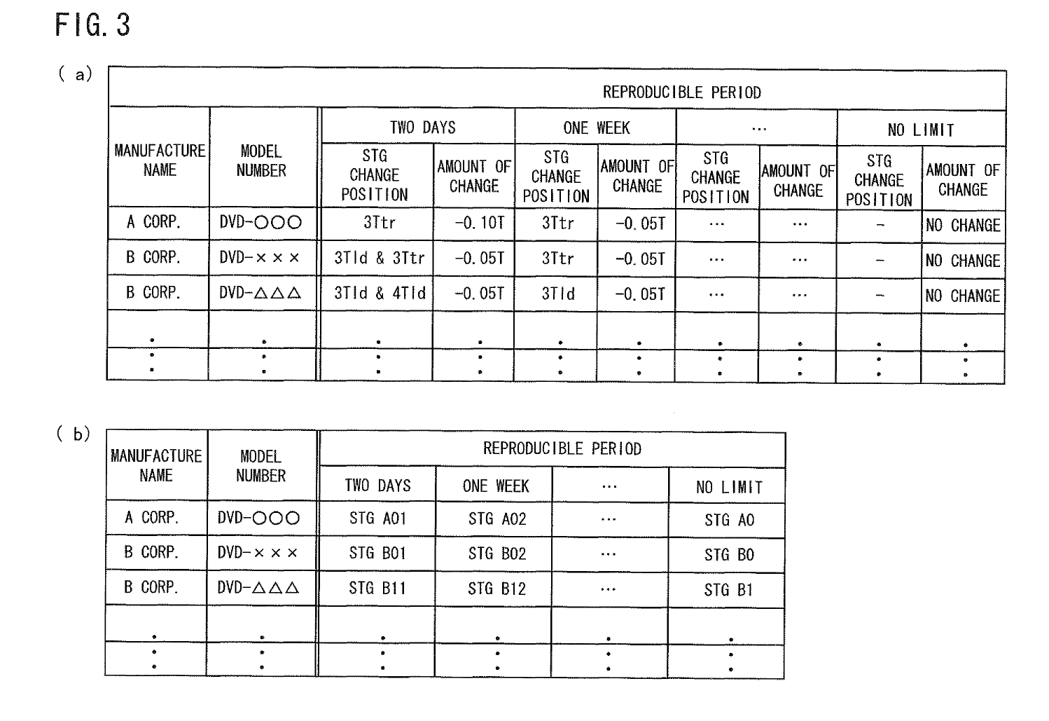

(a) of FIG. 3 illustrates a table indicative of an example of a case where the reproducible period is changed to be limited by changing the write strategy (the widths of write pulses). For example, when the optical disk 1 is an A corp.'s DVD-◯◯◯ and the reproducible period is set to one week, the trailing edge (3 Ttr) of 3 T marks is shifted by 0.05 T toward its leading side (−0.05 T) as compared with a predetermined normal write strategy for DVD-◯◯◯s. Note that the normal write strategy for DVD-◯◯◯s is designed not to limit the reproducible period.

When the optical disk 1 is a B corp.'s DVD-ΔΔΔ and the reproducible period is set to two days, the leading edge (3 Tld) of 3 T marks and the leading edge of 4 T marks (4 Tld) are shifted by 0.05 T toward its trailing side (−0.05 T) as compared with a predetermined normal write strategy for DVD-ΔΔΔs. The normal write strategy for DVD-ΔΔΔs is designed not to limit the reproducible period.

As described above, according to the one embodiment, for each manufacture name and model number, such as each type of the optical disk 1, the amount of change for limiting the reproducible period is stored. For this reason, when a value of the reproducible period is externally instructed, the recording condition controller 10 is adapted to obtain the amount of change corresponding to the type of the optical disk 1 and the instructed value of the reproducible period from the change correspondence table, and to change the recording conditions based on the obtained amount of change.

The write pulse generator 11 is adapted to generate desired write pulses at each of the OPC and data recording, and to send them to the irradiating unit 2. Specifically, at the OPC, the write pulse generator 11 is adapted to generate write pulses based on the write power level for the OPC and the disk information sent from the disk-information obtaining unit 9. At the data recording, the write pulse generator 11 is adapted to generate write pulses based on the information associated with the changed recording conditions and the information associated with the optimum write power level.

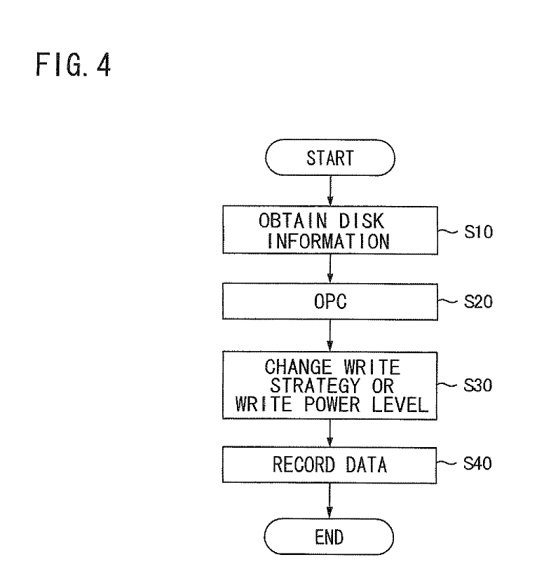

Next, operations of the information recording apparatus 100 according to the one embodiment will be described hereinafter with reference to FIG. 4. FIG. 4 is a flowchart representing operations of the information recording apparatus 100 to write data.

First, the information recording apparatus 100 obtains the disk information of the optical disk 1 previously stored in the optical disk 1 mounted therein (step S10). For example, the disk information includes the manufacture, the model number, the type of the recording layer, the write strategy, and the like.

Next, the information recording apparatus 100 carries out the OPC to thereby find the optimum write power level for the optical disk 1 (step S20). Specifically, the information recording apparatus 100 determines, based on the obtained disk information or previously installed write-strategy information therein, the optimum write power level for the normal recording without limiting the reproducible period.

The information recording apparatus 100 references the change correspondence table of the recording conditions based on the instructed reproduction limiting information (reproducible information) so as to obtain the change information of the recording conditions corresponding to the instructed reproducible information to thereby change the write strategy or the write power level (step S30).

For example) the information recording apparatus 100 reduces the write pulse width for 3 T marks or the power level of the write pulse for 3 T marks.

Next, the information recording apparatus 100 starts data recording using the write strategy and the write power level on one of which the change of the recoding conditions is reflected (step S40).

Note that the operations of the information recording apparatus 100 can be carried out by executing a program stored in the apparatus 100, and the program can be stored in a computer-readable storage medium, such as a ROM, a hard disk, a CD-ROM, a DVD-ROM, or the like or can be downloaded through communication networks.

Next, the change of the recording conditions will be specifically described hereinafter.

### EXAMPLE 1

An example 1 shows that the write strategy for minimum marks 3 T is intentionally changed. The example 1 is carried out based on the fact that the deterioration in the recording characteristics over time markedly appears due to the minimum marks 3 T.

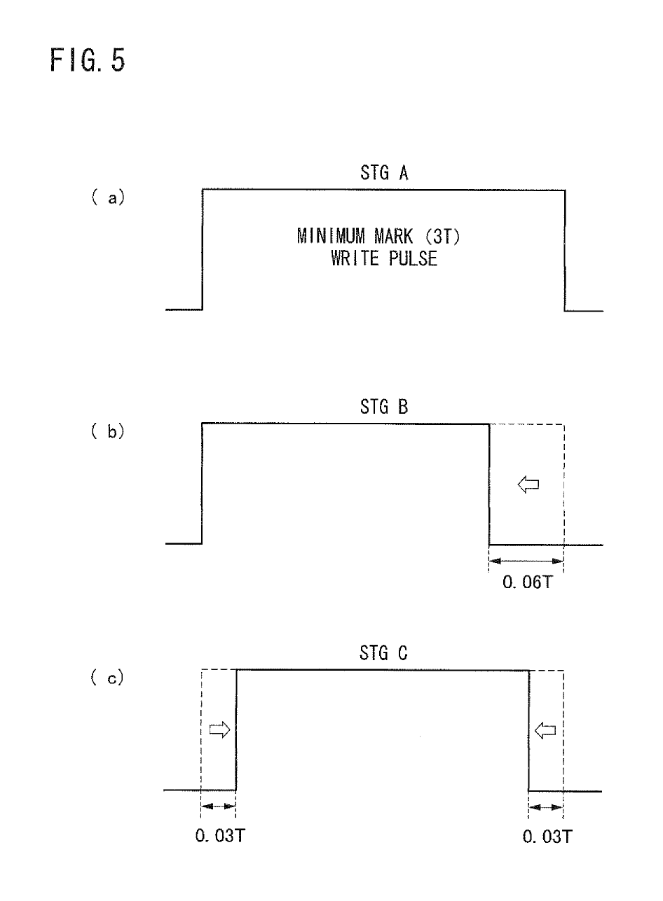

FIG. 5 demonstrates three types of the write strategies for the minimum marks 3 T according to the example 1. (a) of FIG. 5 illustrates an optimum write strategy STGA without changing a minimum mark 3 T, (b) of FIG. 5 illustrates a write strategy STGB to shift, by 0.06 T, the trailing edge of a minimum mark 3 T toward its leading side. (c) of FIG. 5 illustrates a write strategy STGC to shift, by 0.03 T, the leading edge of a minimum mark 3 T toward its trailing side and, to shift by 0.03 T, the trailing edge thereof toward its leading side.

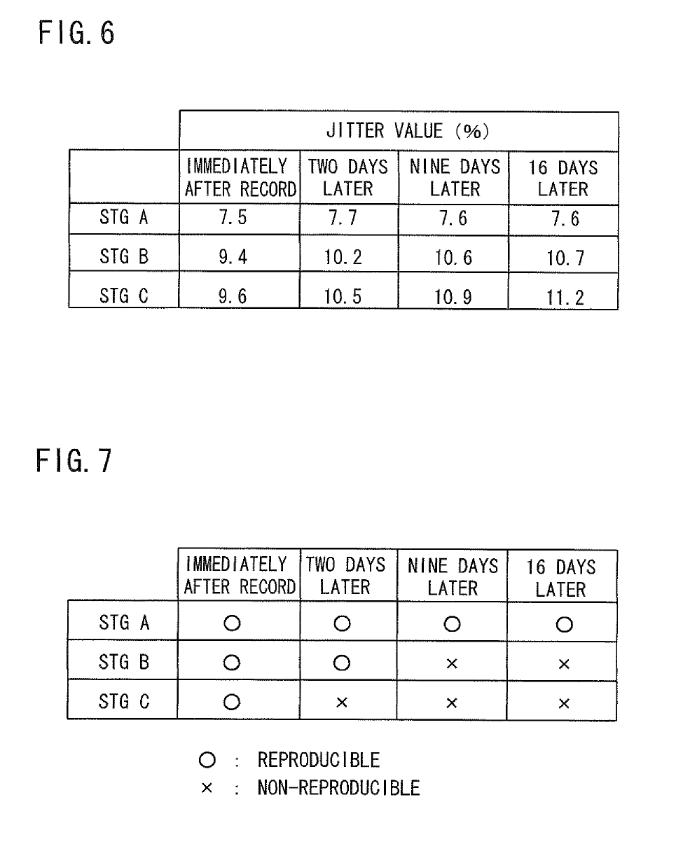

The recoding characteristics obtained when data is recorded on the optical disk 1 with the use of each type of the write strategies illustrated in (a) to (c) of FIG. 5 are illustrated in FIG. 6. FIG. 6 shows, for each type of the write strategies, a jitter value measured immediately after the data recording, a jitter value measured two days after the data recording, a jitter value measured nine days after the data recording, and a jitter value measured by 16 days after the data recording.

FIG. 7 illustrates the reproducing conditions obtained by reproducing the recorded data by an information reproducing apparatus (DVD player) that is impossible to reproduce data when the jitter value reaches 10.5%.

Referring to FIG. 7, the data recorded on the optical disk 1 using the write strategy STGA can be reproduced even if 16 days have elapsed since the data recording. However, the data recorded on the optical disk 1 using the write strategy STGB cannot be reproduced when nine days have elapsed since the data recording, and the data recorded on the optical disk 1 using the write strategy STGC cannot be reproduced when two days have elapsed since the data recording.

As described above, the example 1 clearly demonstrates that the reduction in the width of the write pulses for recording the minimum marks 3 T relative to the optimum write pulse width therefor limits the reproducible period.

### EXAMPLE 2

Like the example 1, an example 2 shows that the write strategy for minimum marks 3 T is intentionally changed. The example 2 is carried out based on the fact that the deterioration in the recording characteristics over time markedly appears due to the minimum marks 3 T.

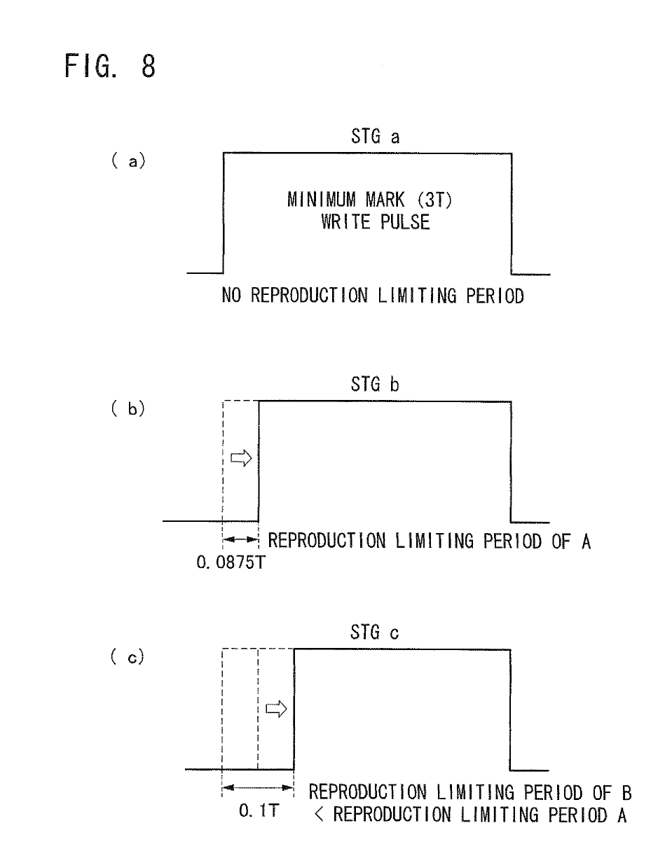

FIG. 8 demonstrates three types of the write strategies for the minimum marks 3 T according to the example 2. (a) of FIG. 8 illustrates an optimum write strategy STGa without changing a minimum mark 3 T, (b) of FIG. 8 illustrates a write strategy STGb to shift, by 0.0875 T, the leading edge of a minimum mark 3 T toward its trailing side. (c) of FIG. 8 illustrates a write strategy STGc to shift, by 0.1 T, the leading edge of a minimum mark 3 T toward its trailing side.

Specifically, in the example 2, the width of write pulses for the minimum marks 3 T using the write strategy STGb is shorter than the width of write pulses for the minimum marks 3 T using the write strategy STGa, and longer than the width of write pulses for the minimum marks 3 T using the write strategy STGc.

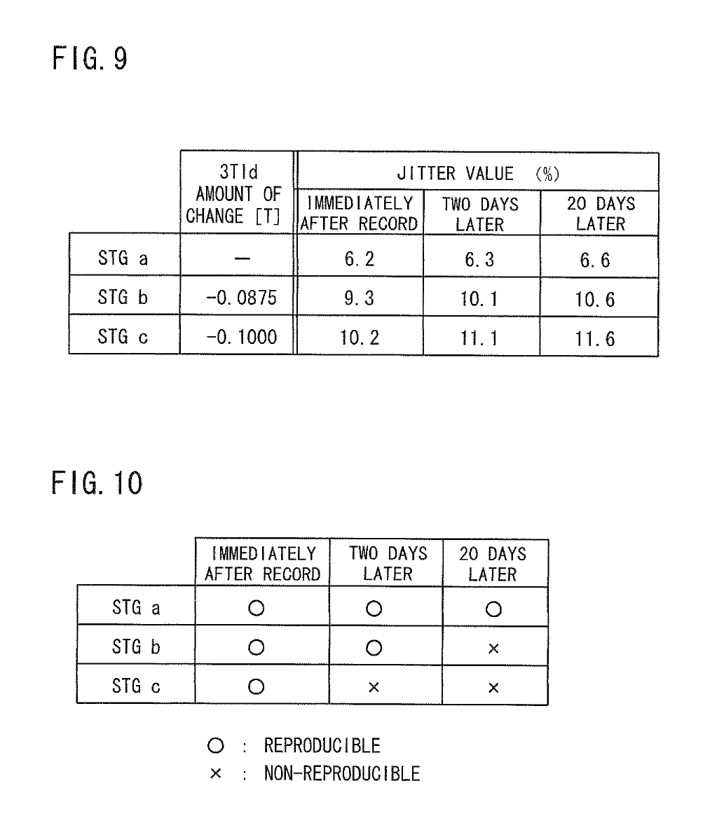

The recoding characteristics obtained when data is recorded on the optical disk 1 with the use of each type of the write strategies illustrated in (a) to (c) of FIG. 8 are illustrated in FIG. 9. FIG. 9 shows, for each type of the write strategies, a jitter value measured immediately after the data recording, a jitter value measured two days after the data recording, and a jitter value measured 20 days after the data recording.

FIG. 10 illustrates the reproducing conditions obtained by reproducing the recorded data by an information reproducing apparatus (DVD player) that is impossible to reproduce data when the jitter value reaches 10.5%.

Referring to FIG. 10, the data recorded on the optical disk 1 using the write strategy STGa can be reproduced even if 20 days have elapsed since the data recording. However, the data recorded on the optical disk 1 using the write strategy STGb cannot be reproduced when 20 days have elapsed since the data recording, and the data recorded on the optical disk 1 using the write strategy STGc cannot be reproduced when two days have elapsed since the data recording.

As described above, the example 2 clearly demonstrates that the reduction in the width of the write pulses for recording the minimum marks 3 T relative to the optimum write pulse width therefor limits the reproducible period.

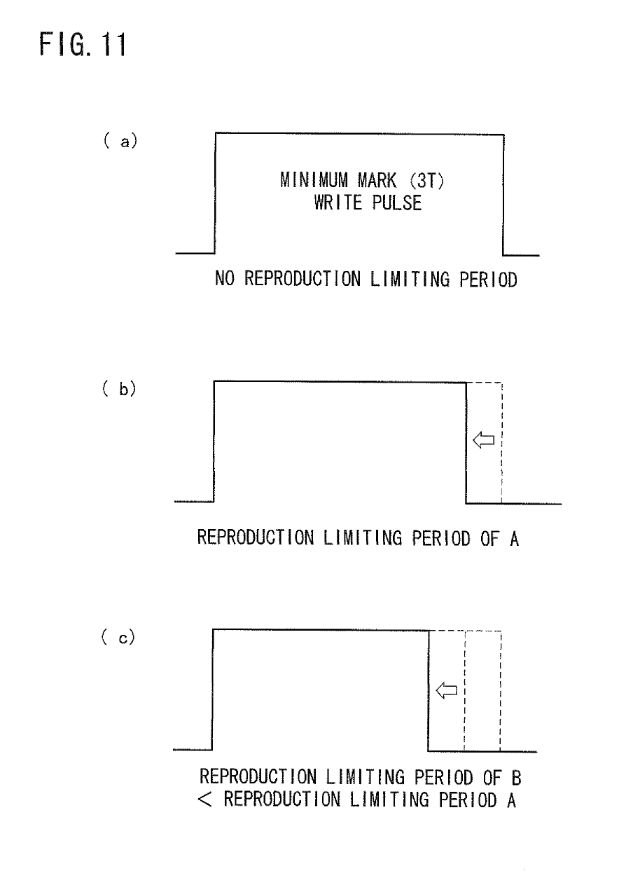

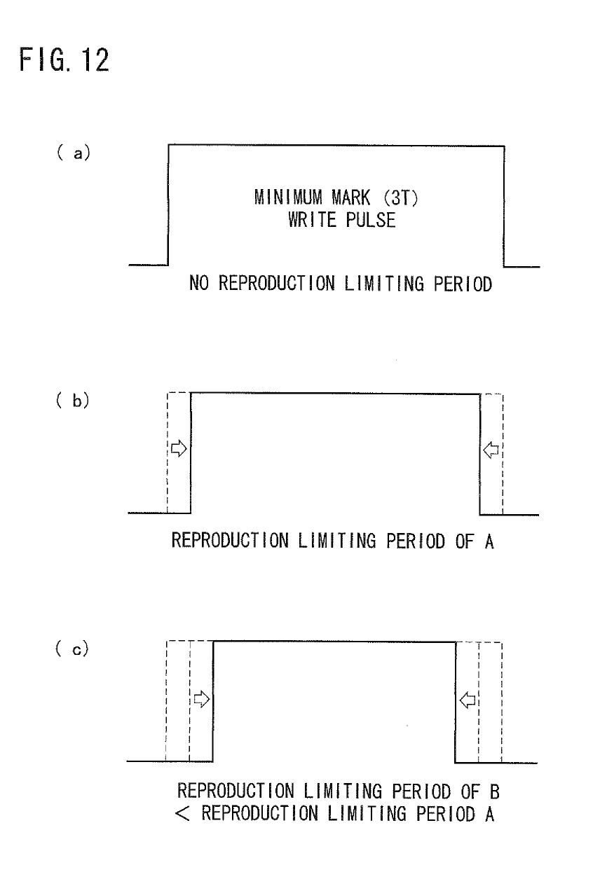

FIGS. 11 and 12 illustrate modifications of the example 2.

FIG. 11 illustrates the shift of the trailing edge of a write pulse for writing a minimum mark 3 T toward the leading side thereof, and another shift of the trailing edge of a write pulse for writing a minimum mark 3 T toward the leading side thereof.

FIG. 12 illustrates the shift of the leading and trailing edges of a write pulse for writing a minimum mark 3 T toward each other, and another shift of the leading and trailing edges of a write pulse for writing a minimum mark 3 T toward each other.

In these modifications, it is possible to limit the reproducible period with reduction in the width of the write pulses for recording the minimum marks 3 T relative to the optimum write pulse width therefor.

### EXAMPLE 3

An example 3 shows that the write power level for minimum marks 3 T is intentionally changed.

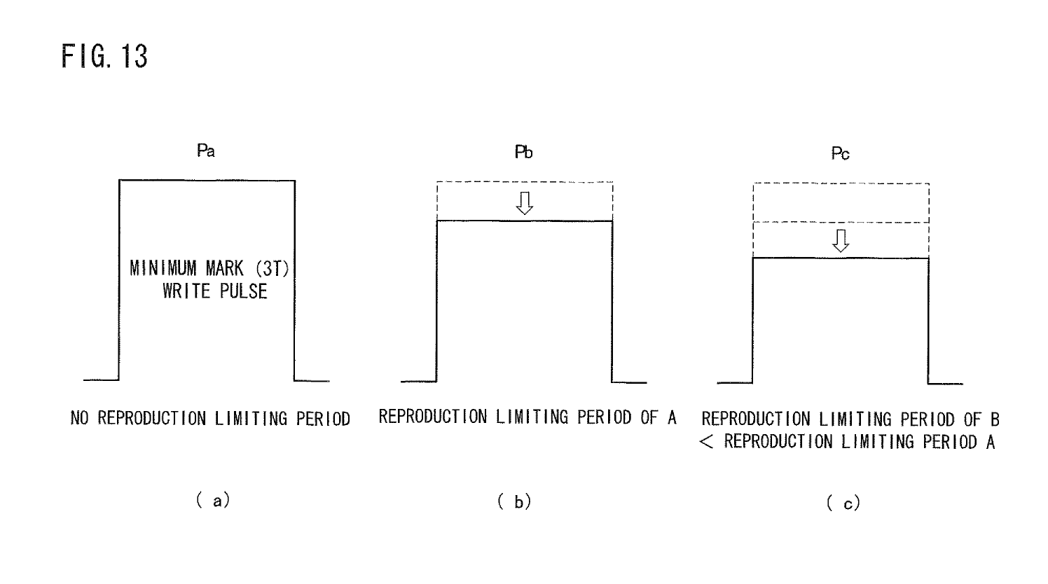

FIG. 13 demonstrates three write power levels for the minimum marks 3 T according to the example 3. (a) of FIG. 13 illustrates an optimum write power level Pa (see the optimum write power level 29 mW), (b) of FIG. 13 illustrates a write power level Pb lower than the optimum write power level Pa, and a write power level Pc lower than the write power level Pb.

According to the example 3, the more reduced the write power level for recording the minimum marks 3 T is, the more reduced the minimum marks 3 T can be over time. Thus, the reduction in the write power level for recording the minimum marks 3 T more limits the reproducible period.

In the examples 1 to 3, it is assumed that the more reduced the width of a recorded mark is, the more deteriorated the recording characteristics is over time. For this reason, the write strategy or the write power level of write pulses for minimum marks 3 T is changed. In place of write pulses for minimum marks 3 T, the write strategy or the write power level of write pulses for another minimum mark can be changed. For example, in addition to change of the write strategy or the write power level of write pulses for minimum marks 3 T, the write strategy or the write power level of write pulses for the second shortest marks 4 T can be changed.

### EXAMPLE 4

In the examples 1 to 3, the write strategy or the write power level for minimum marks 3 T is changed, but an example 4 is different from the structure and configured to change the recording conditions for long marks. Specifically, the example 4 changes the write strategy for write pulses for long marks.

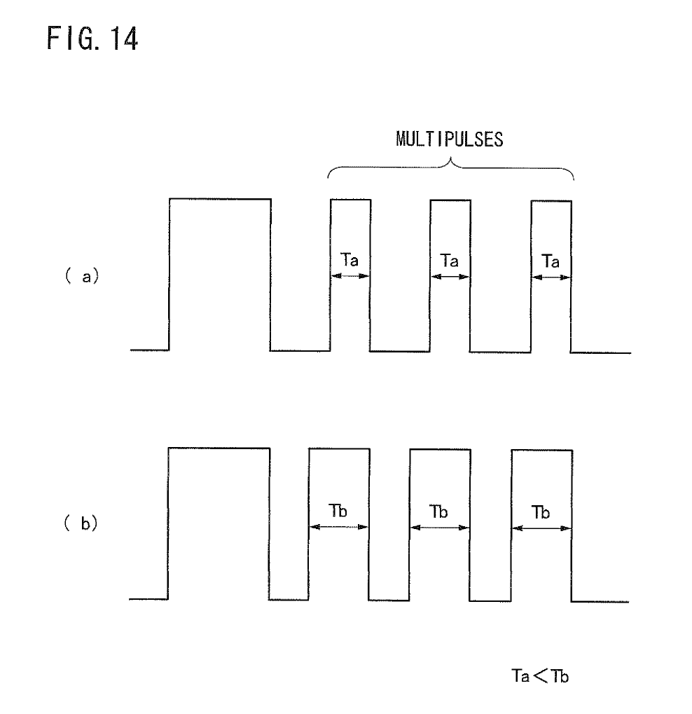

(a) of FIG. 14 illustrates an optimum write strategy for multipulses to be adopted by DVD-R disks at 1× write speed, and (b) of FIG. 14 illustrates a write strategy to increase the width of multipulses relative to the write strategy illustrated in (a) of FIG. 14 (Tb>Ta).

According to the example 4, the more increased the width of write pulses (multipulses) for long marks is by changing the write strategy therefor, the more increased the length of the long marks is. Thus, it is possible to more limit the reproducible period with increase in the width of write pulses (multipulses) for long marks.

### EXAMPLE 5

Like the example 4, an example 5 is configured to change the recording conditions for long marks. Specifically, the example 5 changes the write strategy and/or the write power level of write pulses for long marks.

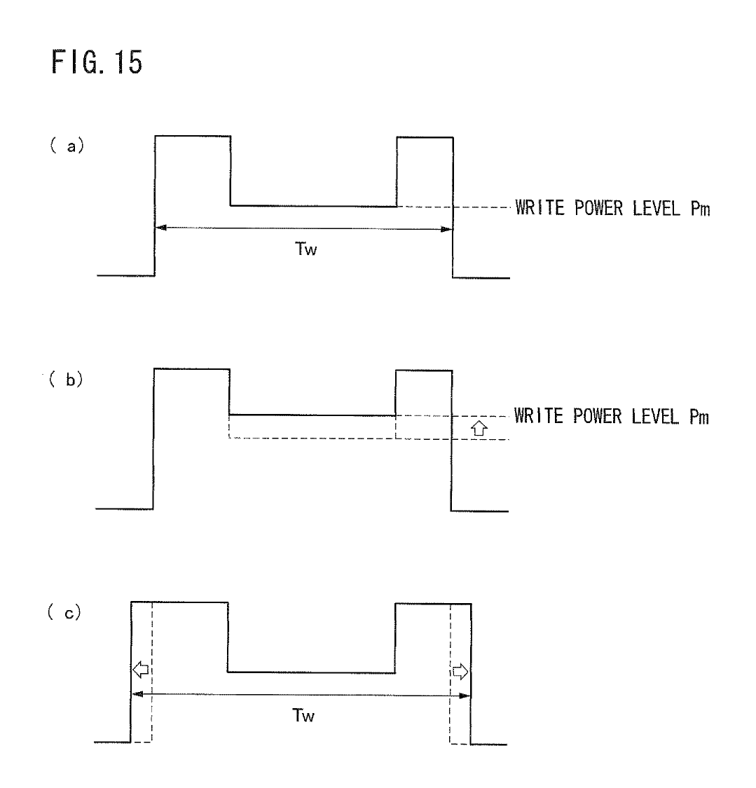

(a) of FIG. 15 illustrates an optimum write strategy for a non-multipulse to be adopted by DVD-R disks at 4× write speed, and (b) of FIG. 15 illustrates a write strategy to increase the write power level Pm of an intermediate bias part of a non-multipulse relative to the write strategy illustrated in (a) of FIG. 15. In addition, (c) of FIG. 15 illustrates a write strategy to increase the width of a non-multipulse relative to the write strategy illustrated in (a) of FIG. 15.

According to the example 5, the more increased the write power level Pm of the intermediate bias part of a non-multipulse for long marks to be recorded is by changing the write strategy therefor, the more increased the length of the long marks is. Thus, it is possible to more limit the reproducible period with increase in the write power level Pm of the intermediate bias part of write pulses (non-multipulses) for long marks.

In addition, the more increased the width of a non-multipulse for long marks to be recorded is, the more increased the length of the long marks is. Thus, it is possible to more limit the reproducible period with increase in the width of write pulses (non-multipulses) for long marks.

### EXAMPLE 6

In the examples 1 to 5, the recording conditions for specific marks to be recorded is changed, but an example 6 changes the write power level for all marks to be recorded to thereby limit the reproducible period.

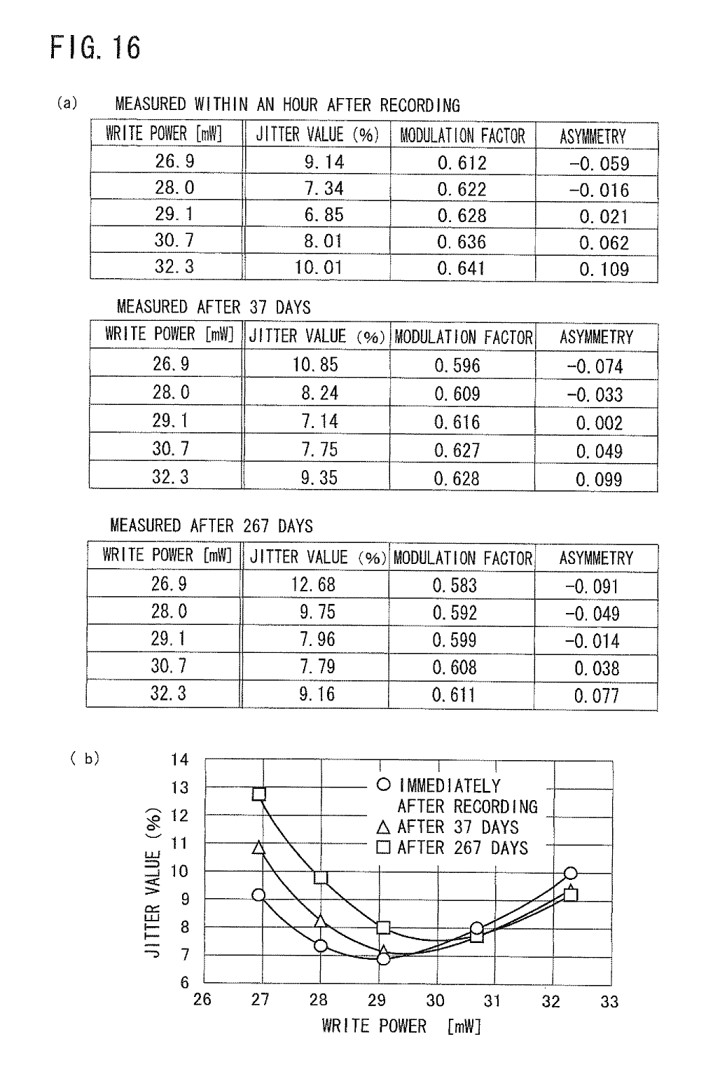

FIG. 16 is a graph part of which is common to FIG. 1. In FIG. 16, measured values of the recording characteristics 37 days later are added. Specifically, (a) of FIG. 16 demonstrates the recording characteristics immediately after the recoding of the data, the recording characteristics after 37 days, and the recording characteristics after 267 days. (b) of FIG. 16 represents the jitter characteristics illustrated in (a) of FIG. 16 as a graph with the vertical axis showing jitter values and the horizontal axis showing the recording power levels.

When an information reproducing apparatus (DVD player), which is impossible to reproduce data when the jitter value reaches 10.5%, tries to reproduce the record data, the data recorded on the optical disk 1 using the optimum write power level of 29.0 mW can be reproduced even if 267 days have elapsed since the data recording.

However, the data recorded on the optical disk 1 using the write power level of 27.7 mW cannot be reproduced when 37 days have elapsed since the data recording.

Thus, according to the example 6, the change of the write power level for all marks to be recorded from the optimum write power level can limit the reproducible period.

As described above, the information recording apparatus 100 according to the one embodiment is configured to change the write power level or the write strategy for the recording conditions based on the type of the optical disk 1 mounted therein and the instructed reproducible period, and thereafter write data. Thus, it is possible to flexibly determine the reproducible period at data recording depending on the application.

Specifically, the information recording apparatus 100 is adapted to:

change, based on the type of the optical disk 1 mounted therein and the instructed reproducible period, the write strategy to thereby reduce the rate of the width of a write pulse to write a short mark to the width of a write pulse to write a long mark; or

change, based on the type of the optical disk 1 mounted therein and the instructed reproducible period, the write power to thereby reduce the rate of the write power level of a write pulse to write a short mark to the write power level of a write pulse to write a long mark.

The change of the write strategy or the write power level allows change of the recording conditions to deteriorate the recording characteristics, thus freely limiting the reproducible period. Because, of course, the recording conditions can be determined without limiting the reproducible period, it is possible to write data without deteriorating the recording characteristics.

Note that, when data recorded on an optical disk is reproduced, it is possible to control the reproducible period based on reproduction control software as a reproduction limiting technique, installed in an information reproducing apparatus. However, in this case, the control function is carried out by only the information reproducing apparatus in which the reproduction control software is installed.

In contrast, the optical disk 1 on which data is recorded with its reproducible period is controlled by the information recording apparatus 100 cannot limit information recording apparatuses, and can be reproduced for all types of information reproducing apparatuses.

### OTHER EMBODIMENTS

In the one embodiment and its examples, the information recording apparatus 100 that controls the reproducible period with the use of Write-Once DVD-R disks as the optical disk 1 has been described, but the present invention is not limited thereto. Specifically, an information recording apparatus 100A that controls the reproducible period with the use of a rewritable optical disk 1A can be used.

Specifically, the information recording apparatus 100A is configured to change the width of cooling pulses used as write pulses for the rewritable optical disk 1A to thereby control a reproducible number thereof.

The cooling pulses are pulses for rapidly cooling the recording layer heated at a high temperature by the write power. For this reason, when the width of cooling pulses is set to be shorter than a preset width, the rapid cooling of the recording layer by the cooling pulses is insufficient so that the recording characteristics are deteriorated. This results in that setting the width of cooling pulses to be shorter than an optimum width allows a reproducible number to be reduced.

Note that, as the optical disk 1A, a rewritable DVD-RW with an AgInSbTe recording layer or GeInSbTe recording layer is used. A more increase in the rate of indium or antimony as compared with a normal rate thereof allows the recording layer to be more susceptible to deterioration by light.

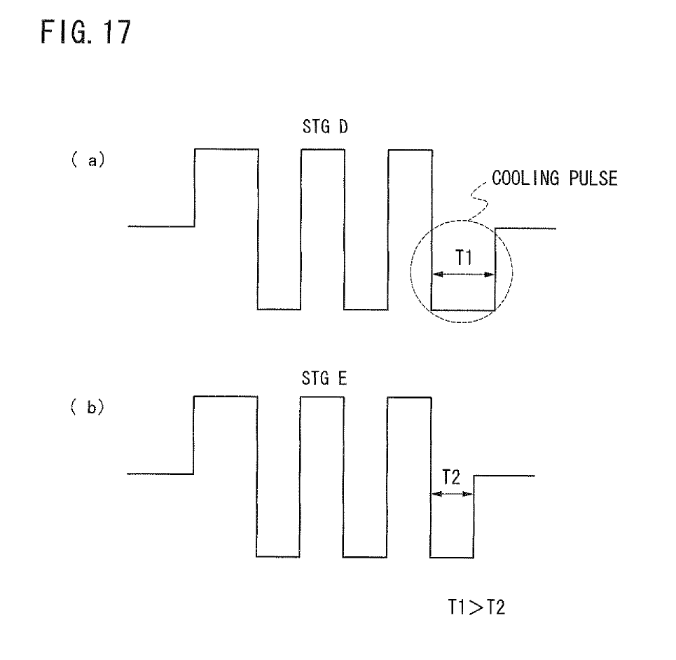

(a) of FIG. 17 illustrates an optimum write strategy STGD when data is recorded by the information recording apparatus 100A at 2× write speed, and (b) of FIG. 17 illustrates a write strategy STGE to reduce the width of a cooling pulse relative to the width of a corresponding cooling pulse by the optimum write strategy STGD. Note that the width of the cooling pulse by the write strategy STGD is 0.8 T, and the width of the cooling pulse by the write strategy STGE is 0.45 T.

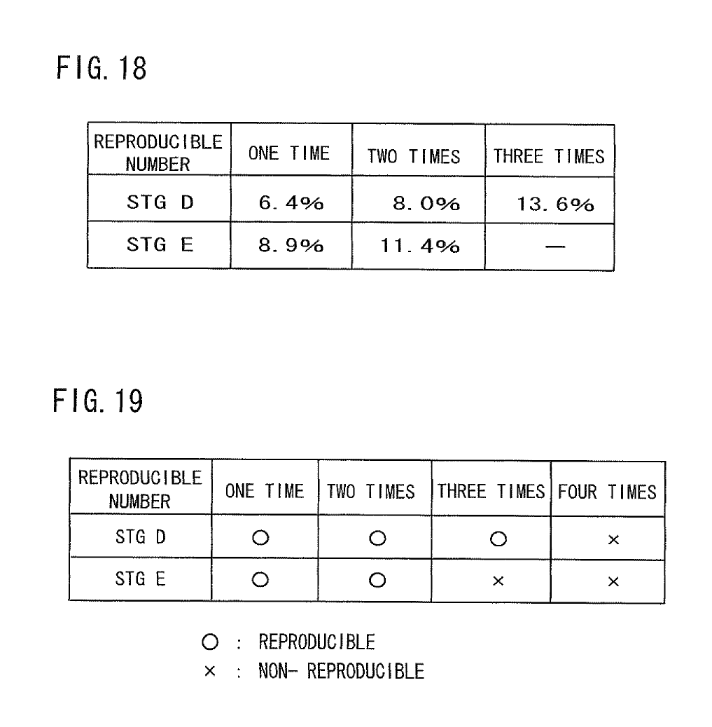

The recoding characteristics obtained when data is recorded on the optical disk 1A with the use of each type of the write strategies illustrated in (a) and (b) of FIG. 17 are illustrated in FIG. 18.

FIG. 18 shows, for each type of the write strategies, a jitter value measured after one time of reproduction, a jitter value measured after two times of reproduction, and a jitter value measured after three times of reproduction.

FIG. 19 illustrates the reproducing conditions obtained by reproducing the recorded data by an information reproducing apparatus (DVD player) that is impossible to reproduce data when the jitter value reaches 10.5%.

Referring to FIG. 19, the data recorded on the optical disk 1A using the write strategy STGD can be reproduced up to three times of reproduction, but the data recorded on the optical disk 1A using the write strategy STGE can be reproduced only up to two times of reproduction.

As described above, the next embodiment clearly demonstrates that the reduction in the width of the cooling pulses by changing the write strategy limits a reproducible number.

In addition to the control of the width of cooling pulses, it is possible to control the width of top pulses or multipulses to thereby similarly limit a reproducible number.

Note that, in the one and next embodiments, when the recording conditions are changed, the change of the write strategy or the write power is applied to all target write signals, but the present invention is not limited thereto. Specifically, the change of the write strategy or the write power can be applied to at least one target write signal.

For example, for limit of a reproducible number, the write strategy or the write power of at least one target write signal for a portion of the optical disk 1A can be changed in consideration of reproductions of missed scenes so that data can be recorded thereon based on the changed write strategy or write power; this portion is read each time the optical disk 1A is mounted.

In the one and next embodiments, the change correspondence table is stored in the information recording apparatuses, but the present invention is not limited thereto. The change correspondence table can be stored in information recording media, or can be stored both the information recording apparatuses and information recording media.

For example, when the information recording apparatus provided with the change correspondence table records data on an information recording medium, the information recording apparatus can store the change correspondence table on the information recording medium.

In addition, in the one and next embodiments, the information recording apparatus is installed with the change correspondence table to thereby store the amounts of change for the recording conditions. However, the information recording apparatus can be installed with a plurality of write strategies each corresponding to a reproducible period or a reproducible number.

(b) of FIG. 3 illustrates a table indicative of an example of a case where the reproducible period is changed to be limited.

For example, when the optical disk 1 is an A corp.'s DVD-◯◯◯ and the reproducible period is set to two days, a write strategy STGA01 is used to record data. When the optical disk 1 is a B corp.'s DVD-XXX and the reproducible period is set to one week, a write strategy STGB02 is used to record data.

As described above, according to the modification, for each manufacture name and model number, such as each type of the optical disk, the write strategy for limiting the reproducible period can be stored. When a value of the reproducible period is externally instructed, it is possible to obtain an optimum write strategy corresponding to the type of the optical disk and the instructed value of the reproducible period from the change correspondence table, and to change the recording conditions based on the obtained write strategy.

1. An information recording apparatus comprising:
recording condition determining means for determining at least one recording condition to recode data on an information recording medium;
reproducible period inputting means for inputting a parameter value associated with a reproducible period;
recording condition changing means for changing, based on the parameter value inputted by the reproducible period inputting means, a recording condition associated with a write strategy in the at least one recording condition determined by the recording condition determining means; and
information recording means for recording, on the information recording medium, data based on a write signal and the recording condition changed by the recording condition changing means and associated with the write strategy,
wherein the recording condition associated with the write strategy includes a rate of a width of a write pulse included in the write signal to write a short mark to a width of a write pulse included in the write signal to write a long mark, the short mark having a length shorter than a predetermined length, the long mark having a length longer than the predetermined length, and
the recording condition changing means reduces the rate determined by the recording condition determining means.

2. The information recording apparatus according to claim 1, wherein the recording condition changing means reduces the width of the write pulse to write the short mark, the width of the write pulse to write the short mark being determined based on the rate determined by the recording condition determining means.

3. The information recording apparatus according to claim 1, wherein the recording condition changing means increases the width of the write pulse to write the long mark, the width of the write pulse to write the long mark being determined based on the rate determined by the recording condition determining means.

4. The information recording apparatus according to claim 3, wherein, when the write signal includes multipulses as the write pulse to write the long mark, the recording condition changing means increases the width of at least one of the multipulses, the width of the at least one of the multipulses being determined based on the rate determined by the recording condition determining means.

5. An information recording apparatus comprising:
recording condition determining means for determining at least one recording condition to recode data on an information recording medium;
reproducible period inputting means for inputting a parameter value associated with a reproducible period;
recording condition changing means for changing, based on the parameter value inputted by the reproducible period inputting means, a recording condition associated with a write power in the at least one recording condition determined by the recording condition determining means; and
information recording means for recording, on the information recording medium, data based on the recording condition changed by the recording condition changing means and associated with the write power,
wherein the recording condition associated with the write power includes a rate of a write power level of a write signal to write a short mark to a write power level of a write signal to write a long mark, the short mark having a length shorter than a predetermined length, the long mark having a length longer than the predetermined length, and
the recording condition changing means reduces the rate determined by the recording condition determining means.

6. The information recording apparatus according to claim 5, wherein the recording condition changing means reduces the write power level of the write signal to write the short mark, the write power level of the write signal to write the short mark being determined based on the rate determined by the recording condition determining means.

7. The information recording apparatus according to claim 5, wherein the recording condition changing means increases the write power level of the write signal to write the long mark, the write power level of the write signal to write the long mark being determined based on the rate determined by the recording condition determining means.

8. The information recording apparatus according to claim 7, wherein, when the write signal to write the long mark is a non-multipulse signal, the recording condition changing means increases the write power level of an intermediate bias part of the non-multipulse signal, the write power level of the intermediate bias part of the non-multipulse signal being determined based on the rate determined by the recording condition determining means.

9. The information recording apparatus according to claim 2, wherein the short mark includes a minimum mark.

10. The information recording apparatus according to claim 9, wherein the short mark includes the minimum mark and a second shortest mark.

11. An information recording apparatus comprising:
recording condition determining means for determining at least one recording condition to recode data on an information recording medium;
reproducible period inputting means for inputting a parameter value associated with a reproducible period;
recording condition changing means for changing, based on the parameter value inputted by the reproducible period inputting means, a recording condition associated with a write power in the at least one recording condition determined by the recording condition determining means; and
information recording means for recording, on the information recording medium, data based on the recording condition changed by the recording condition changing means and associated with the write power,
wherein the recording condition associated with the write power includes a write power level of each of a plurality of write signals to write a plurality of marks, respectively, each of the plurality of marks including a length, and
the recording condition changing means carries out the changing such that the write power level of each of the plurality of write signals to write the plurality of marks is reduced than an optimum write power level determined by the recording condition determining means.

12. An information recording apparatus comprising:
recording condition determining means for determining at least one recording condition to recode data on an information recording medium;
reproducible number inputting means for inputting a parameter value associated with a reproducible number;
recording condition changing means for changing, based on the parameter value inputted by the reproducible number inputting means, a recording condition associated with a write strategy in the at least one recording condition determined by the recording condition determining means; and
information recording means for recording, on the information recording medium, data based on a write signal and the recording condition changed by the recording condition changing means and associated with the write strategy,
wherein the recording condition associated with the write strategy includes a length of a width of a write pulse included in the write signal to write a mark, and
the recording condition changing means reduces the length of the width of the write pulse included in the write signal determined by the recording condition determining means.

13. The information recording apparatus according to claim 12, wherein the width of the write pulse included in the write signal is a width of a cooling pulse included in the write signal.

14. The information recording apparatus according to claim 1, further comprising a recording condition change table that stores therein a value associated with change of the recording condition for each of a type of the information recording medium and the parameter value,
wherein the recording medium changing means carries out change of the recording condition by referencing, based on the type of the information recording medium and the parameter value, the value of the recording condition stored in the recording condition change table, the referenced value corresponding to the type of the information recording medium and the parameter value.

15. The information recording apparatus according to claim 1, wherein the predetermined length is a diameter of a spot of a laser beam focused as the write signal on the information recording medium when the data is recorded on the information recording medium.

16. The information recording apparatus according to claim 1, wherein the recording condition changing means carries out change of the recording condition for part of the write signal.

17. An information recording apparatus comprising:
means for obtaining information associated with an information recording medium, the information being stored in the information recording medium;
means for determining, based on at least one of a write strategy of the obtained information and information previously stored in the apparatus, an optimum write power level that does not deteriorate a reproducing characteristic;
means for inputting a parameter value associated with deterioration of the reproducing characteristic;
means for changing, based on the inputted parameter value, at least one of the write strategy and the determined optimum write power level after the optimum write power level has been determined; and
means for recording data on the information recording medium according to at least one of the changed write strategy and the changed write power level.

18. An information recording medium including data recorded therein by the information recording apparatus according to claim 17.

19. An information recording medium including data recorded therein by the information recording apparatus according to claim 17, comprising:
a recording condition change table that stores therein a value associated with change of the recording condition based on the parameter value.

20. The information recording medium according to claim 19, wherein data in the recording condition change table is stored by the information recording apparatus.

21. An information recording program functioning a computer as:
recording condition determining means for determining at least one recording condition to recode data on an information recording medium;
reproducible period receiving means for receiving a parameter value associated with a reproducible period;
recording condition changing means for changing, based on the parameter value inputted by the reproducible period inputting means, a recording condition associated with a write strategy in the at least one recording condition determined by the recording condition determining means; and
information recording means for recording, on the information recording medium, the data based on a write signal and the recording condition changed by the recording condition changing means and associated with the write strategy,
wherein the recording condition associated with the write strategy includes a rate of a width of a write pulse included in the write signal to write a short mark to a width of a write pulse included in the write signal to write a long mark, the short mark having a length shorter than a predetermined length, the long mark having a length longer than the predetermined length, and
the recording condition changing means reduces the rate determined by the recording condition determining means.

22. An information recording program functioning a computer as:
recording condition determining means for determining at least one recording condition to recode data on an information recording medium;
reproducible period receiving means for receiving a parameter value associated with a reproducible period;
recording condition changing means for changing, based on the parameter value inputted by the reproducible period inputting means, a recording condition associated with a write power in the at least one recording condition determined by the recording condition determining means; and
information recording means for recording, on the information recording medium, the data based on the recording condition changed by the recording condition changing means and associated with the write power,
wherein the recording condition associated with the write power includes a rate of a write power level of a write signal to write a short mark to a write power level of a write signal to write a long mark, the short mark having a length shorter than a predetermined length, the long mark having a length longer than the predetermined length, and
the recording condition changing means reduces the rate determined by the recording condition determining means.

23. An information recording program functioning a computer as:
recording condition determining means for determining at least one recording condition to recode data on an information recording medium;
reproducible number receiving means for receiving a parameter value associated with a reproducible number;
recording condition changing means for changing, based on the parameter value inputted by the reproducible number inputting means, a recording condition associated with a write strategy in the at least one recording condition determined by the recording condition determining means; and
information recording means for recording, on the information recording medium, data based on a write signal and the recording condition changed by the recording condition changing means and associated with the write strategy,
wherein the recording condition associated with the write strategy includes a length of a width of a write pulse included in the write signal to write a mark, and
the recording condition changing means reduces the length of the width of the write pulse of the write signal determined by the recording condition determining means.
